(19) United States
(12) Patent Application Publication
(10) Pub. No.: US 2019/0279079 A1
(43) Pub. Date: Sep. 12, 2019

(54) NEUROMORPHIC SYSTEM WITH TRANSPOSABLE MEMORY AND VIRTUAL LOOK-UP TABLE

(71) Applicant: POSTECH ACADEMY-INDUSTRY FOUNDATION, Pohang-si (KR)

(72) Inventors: Jae Yoon SIM, Pohang-si (KR); Hwa Suk CHO, Daejeon-si (KR); Hyun Woo SON, Bucheon-si (KR)

(21) Appl. No.: 16/276,452

(22) Filed: Feb. 14, 2019

(30) Foreign Application Priority Data
Mar. 8, 2018 (KR) 10-2018-0027307

(51) Int. Cl. G06N 3/063; G06N 3/08; G06N 20/00; G06F 1/03

(52) U.S. Cl. CPC G06N 3/0635; G06F 1/03; G06N 20/00; G06N 3/08

(57) ABSTRACT

Provided is a technology for reducing hardware cost and enabling on-chip learning in a neuromorphic system. A synapse array includes a plurality of synapse circuits, and at least one of the plurality of synapse circuits includes at least bias transistor and a switch connected in series. Synapse circuits in the same row and column direction of the synapse array are connected to each other through a shared membrane line, and a charge amount proportional to a multiplication accumulation operation required for a forward or backward operation is supplied through the membrane line and is converted into a final digital value for output through an analog to digital converter. A virtual look-up table performs in advance a calculation required for a synapse weight update for learning of at least one column of the synapse array and is updated, so that the amount of a calculation required for entire learning is reduced.

### BACKGROUND

### 1. Technical Field

The present disclosure relates to a technology for reducing hardware cost and enabling on-chip learning in a neuromorphic system, and more particularly, to an on-chip learning neuromorphic system with a memory and a virtual look-up table, by which a forward operation and an backward operation required for learning can be performed using a current-mode transposable memory and weight values of synapses are updated by row by using the virtual look-up table, so that a calculation amount required for learning and hardware cost can be reduced.

### 2. Related Art

A neuromorphic system is a system obtained by implementing an artificial neural network imitating the brain of an organism (human) by using a semiconductor circuit, and is a model in which nodes forming a network through synapse connections have an arbitrary problem solving ability by changing synapse weight values through learning. The neuromorphic learning refers to changing the synapse weight values to have a proper problem solving ability. In general, an operation of the neuromorphic system is a forward operation, but a backward operation is also required for learning.

When inputs for the forward operation and the backward operation of the neuromorphic system are respectively represented by a vector IN_{F} with a size of 1×M and a vector IN_{B} with a size of 1×N and synapse weight values of the artificial neural network are represented by a matrix with a size of M×N, output values of the forward operation and the backward operation may be represented by a vector OUT_{F} with a size of 1×N and a vector OUT_{B} with a size of 1×M through matrix multiplications as expressed by the following Equation 1 and Equation 2.

OUT_{F}=/IN_{F}*W Equation 1

OUT_{B}=IN_{B}*W^{T} Equation 2

As expressed by Equation 1 and Equation 2 above, when a matrix having synapse weight values used in the forward operation of the neuromorphic system is W, synapse weight values to be used in the backward operation are a transposed W matrix. Accordingly, a transposable memory should be used for on-chip learning of the neuromorphic system, and respective synapse weight values can be changed in a direction in which an error is reduced through the backward operation of the artificial neural network.

As described above, the neuromorphic system is allowed to process new types of information through the on-chip learning, so that the neuromorphic system can be applied wherever a self-adaptable intelligent system using information obtained from an unspecified environment is implemented.

However, the neuromorphic system according to the related art has a problem that much power is required for performing the forward and backward operations necessary for learning.

### SUMMARY

Various embodiments are directed to reduce an amount of a multiplication required for learning by using a current-mode transposable memory for a backward operation and a virtual look-up table in order to minimize hardware cost and enable on-chip learning in a neuromorphic system.

Various embodiments are directed to perform a multiplication accumulation operation used in forwarding and backwarding operations by using a current, which is an analog signal, instead of a digital signal, in order to implement a lower power on-chip learning neuromorphic system.

In an embodiment, a neuromorphic system with a transposable memory and a virtual look-up table includes a multi-bit synapse array including a plurality of synapse circuits based on a SRAM structure, an analog to digital converter that converts a voltage charged in a membrane line by charge supplied according to a multiplication accumulation operation result in the multi-bit synapse array into a digital value, a pulse width modulation circuit that generates a pulse width modulation signal having a duty ratio proportional to a multi-bit digital input value and outputs the pulse width modulation signal to the multi-bit synapse array, and a neuronal processor that receives output data of the analog to digital converter, outputs the multi-bit digital input value, transfers forward and backward input values supplied from an exterior to the multi-bit synapse array, applies a nonlinear function to the multiplication accumulation operation result so as to perform processing required after a multiplication accumulation operation of an artificial neural network, and updates a synapse weight value of the multi-bit synapse array in a direction in which an error is reduced using a learning algorithm.

The neuronal processor includes a decoder that outputs a corresponding address value by using all or partial bits of a column component used in order to calculate a synapse update change amount as input, a virtual look-up table that stores a calculation value related to the synapse update change amount by using all bits or only partial bits of the column component on the basis of a row component required for calculating the synapse update change amount and the corresponding address value and stores a calculation value generated again whenever the row component is changed, a demultiplexer that distributes output of the virtual look-up table to two paths according to a batch signal indicating whether batch learning is performed and outputs the output, an accumulator that accumulates the output of the virtual look-up table, and a tri-level function unit that receives output of the demultiplexer and output of the accumulator and outputs the synapse update change amount as three levels of information

The neuromorphic system adds the synapse update change amount to the synapse weight value of the multi-bit synapse array and updates the synapse weight value in a row-by-row manner.

According to the present disclosure, when a neuromorphic system performs neuromorphic learning, forward and backward operations necessary for learning can be performed with low power by using a current-mode transposable memory and a current-mode multiplier-accumulator, so that on-chip learning becomes possible.

Furthermore, a large amount of operations required for learning are reduced using a virtual look-up table, so that hardware cost required for learning of a neuromorphic system is minimized.

### BRIEF DESCRIPTION OF THE DRAWINGS

FIG. 1 is a diagram illustrating an overall structure of a neuromorphic system with a transposable memory and a virtual look-up table according to the present disclosure.

FIG. 2 is a diagram illustrating a multi-bit synapse circuit included in a neuromorphic system according to the present disclosure.

FIG. 3 is a circuit diagram of a current-mode multiplier-accumulator included in a neuromorphic system according to the present disclosure.

FIG. 4 is an explanation diagram of an operation of a synapse update change amount in a neuromorphic system with a transposable memory and a virtual look-up table according to the present disclosure.

(a) of FIG. 5 illustrates MNIST images used as inputs of a neuromorphic system according to the present disclosure.

(b) of FIG. 5 illustrates images restored before learning by a neuromorphic system according to the present disclosure.

(c) of FIG. 5 illustrates images restored after learning by a neuromorphic system according to the present disclosure.

### DETAILED DESCRIPTION

Exemplary embodiments of the present disclosure will be described below in detail with reference to the accompanying drawings.

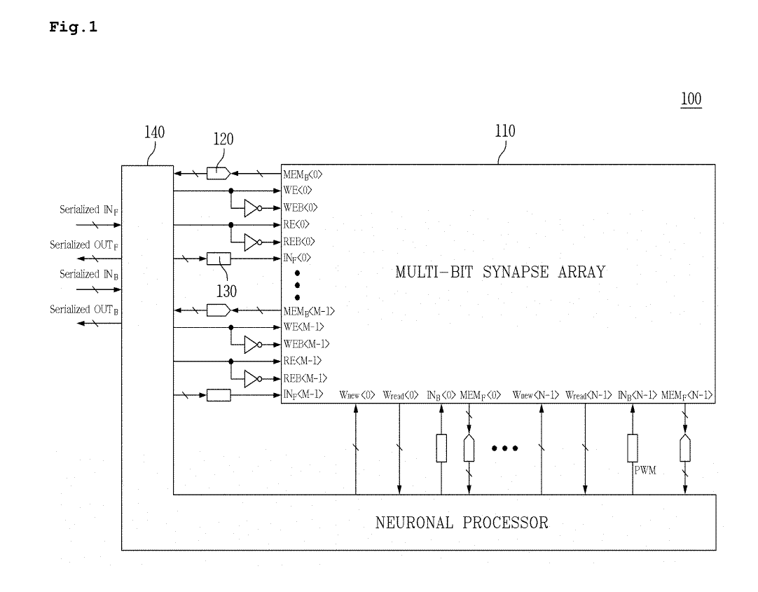

FIG. 1 is a block diagram of an on-chip learning neuromorphic system with a current-mode transposable memory and a virtual look-up table according to the present disclosure. As illustrated in FIG. 1, a neuromorphic system 100 includes a SRAM-based synapse array of multi-bits (hereinafter, referred to as a “multi-bit synapse array”) 110, an analog to digital (A/D) converter 120, a pulse width modulation (PWM) circuit 130, and a neuronal processor 140.

The multi-bit synapse array 110 stores synapse weight values of an artificial neural network.

In a write enable signal WE<i>, a write enable bar signal WEB<i>, a read enable signal RE<i>, and a read enable bar signal REB<i> of the multi-bit synapse array 110, i indicates the order of rows. For example, when the multi-bit synapse array 110 has a size of M×N, i may have a natural number of “0” to “M-1”. When a logic value of the write enable signal WE<i> is “1”, the neuronal processor 140 stores a weight update value W_{new} of an update target synapse obtained from a learning algorithm in synapses of a corresponding row. When a logic value of the read enable signal RE<i> is “1”, the neuronal processor 140 reads the value stored in the synapses of the corresponding row through a read line W_{read}. A forward operation input value IN_{F}<i> and a backward operation input value IN_{B}<j> are respectively input values for a forward operation and a backward operation, and when the multi-bit synapse array 110 has a size of M×N, i and j respectively have a natural number of “0” to “M-1” and a natural number of “0” to “N-1”. The following i and j indicate the order of rows and columns of the multi-bit synapse array 110, respectively. A multi-bit digital input value supplied from the neuronal processor 140 to the multi-bit synapse array 110 is modulated into a pulse width signal having a duty ratio proportional to the input value through the pulse width modulation circuit 130, and then is transferred to synapses of the row and the column indicated by i and j.

When the multi-bit synapse array 110 is implemented with the size of M×N, the neuromorphic system 100 includes N units of column direction membrane lines MEM_{F}<0:N-1> for the forward operation and M units of row direction membrane lines MEM_{B}<0:M-1>for the backward operation. For an operation of a multi-bit synapse in the multi-bit synapse array 110, one unit of membrane line may be configured from at least one through multi-bit synapse sharing to the number of bits of a maximum synapse without sharing. In the multi-bit synapse array 110, since row and column direction synapses are respectively connected to the column direction and row direction membrane lines MEM_{F}<0:N-1> and MEM_{B}<0:M-1>, it can be understood that synapse weight values used in the forward operation and the backward operation are transposed. The total amount of charge supplied to the column direction and row direction membrane lines MEM_{F}<0:N-1> and MEM_{B}<0:M-1> is decided by a result of a multiplication accumulation operation of the artificial neural network using a current, and the total charge amount decided as above is converted into a digital value through the analog to digital converter 120 and then is transferred to the neuronal processor 140.

The neuronal processor 140 serves as a serializer and a deserializer that convert forward and backward input values supplied in series into a parallel form, transfer the converted input values to the multi-bit synapse array 110, and convert the result of the multiplication accumulation operation supplied in a parallel form from the multi-bit synapse array 110 into a serial form.

The neuronal processor 140 applies a nonlinear function such as a rectified linear unit (ReLU) and a sigmoid to the result of the multiplication accumulation operation, thereby performing processing required after the multiplication accumulation operation of the artificial neural network. The neuronal processor 140 may update the synapse weight values of the multi-bit synapse array 110 in a direction in which an error is reduced through a learning algorithm. The learning algorithm may be largely classified into unsupervised learning and supervised learning, and hereinafter, an update of the synapse weight values of the multi-bit synapse array 110 through the unsupervised learning will be described as an example.

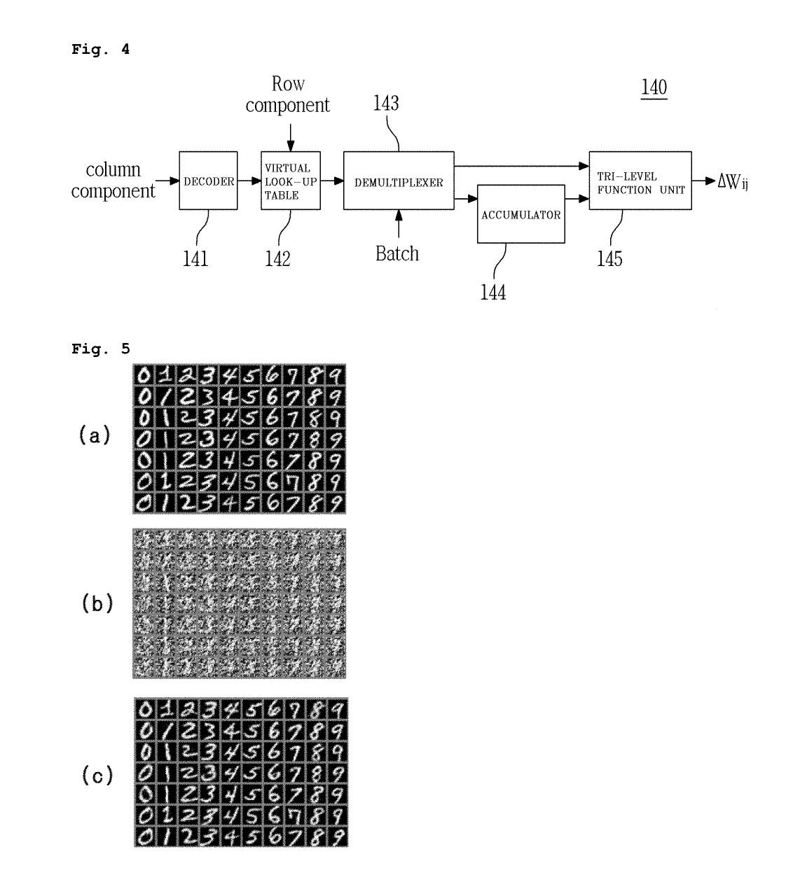

In the neuronal processor 140, a calculation amount required for the learning increases in proportional to the size of the multi-bit synapse array 110, and in order to minimize the calculation amount, a look-up table is used and synapse weight values to be updated are limited to +1, 0, and −1. A synapse update operation using the look-up table will be described below in detail with reference to FIG. 4. The neuronal processor 140 performs an update of one row at a time on the multi-bit synapse array 110. In such a case, the neuronal processor 140 obtains synapse weight values to be updated of an x^{th} row by using the look-up table on the multi-bit synapse array 110, adds the synapse weight values to synapse values of the x^{th} row read from the multi-bit synapse array 110 by using a RE<x> signal, and sets synapse weight values W_{new}<0:N-1> to be updated. Then, the neuronal processor 140 updates the synapse weight values of the x^{th} row of the multi-bit synapse array 110 by using a WE<x> signal.

When the neuromorphic system 100 performs a multiplication accumulation operation by using an analog signal, the operation result may be greatly affected by mismatch between devices and a process voltage temperature (PVT) variation, but when on-chip learning is possible, the synapse weight values of the multi-bit synapse array 110 are properly changed through learning, the above influence to the operation result is minimized.

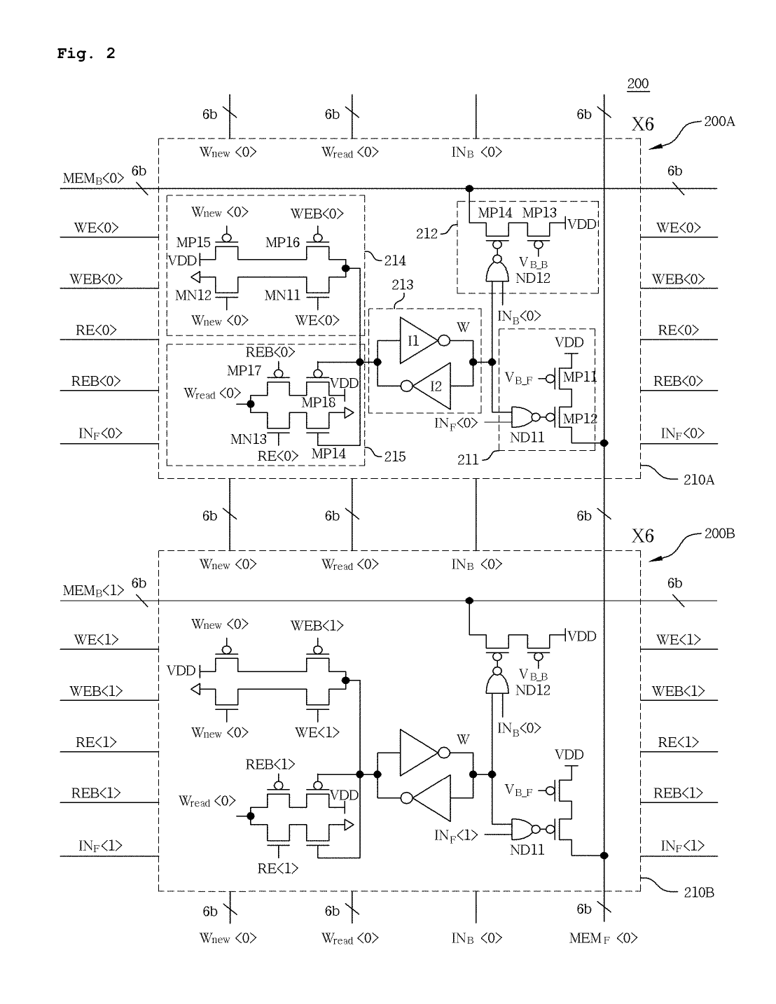

FIG. 2 illustrates a synapse circuit of multi-bits (hereinafter, referred to as a “multi-bit synapse circuit”) provided in the multi-bit synapse array 110. FIG. 2 exemplifies that a multi-bit synapse circuit 200 is implemented as a 6-bit (6b) synapse array with a size of 2×1.

Referring to FIG. 2, the multi-bit synapse circuit 200 includes synapse circuit blocks 200A and 200B.

The synapse circuit block 200A includes six synapse circuits 210A having the same configuration in order to implement multi-bits (for example, 6b). Similarly, the synapse circuit block 200B includes six synapse circuits 210B having the same configuration in order to implement multi-bits (for example, 6b).

Since the configuration and operation of the synapse circuit block 200A and the synapse circuit block 200B are identical to each other and the configuration and operation of the synapse circuit 210A and the synapse circuit 210B are also identical to each other, the synapse circuit 210A provided in the synapse circuit block 200A will be described below as an example.

The synapse circuit 210A includes a forward operation unit 211, a backward operation unit 212, a SRAM 213, a write operation unit 214, and a read operation unit 215.

The forward operation unit 211 includes a transistor MP11 for a current source, which has one terminal (a source) connected to a power supply voltage VDD and a gate supplied with a forward bias voltage V_{B}_{_}_{F}, a transistor MP12 for a switch connected between the other terminal (a drain) of the transistor MP11 for a current source and the column direction membrane line MEM_{F}<0>, and a NAND gate ND11 which has one terminal connected to an output terminal of the SRAM 213, the other terminal supplied with a pulse width modulation signal IN_{F}<0> having a duty ratio proportional to a multi-bit forward input value, and an output terminal connected to a gate of the transistor MP12 for a switch.

The transistor MP11 for a current source serves as a current source that supplies a current for a multiplication accumulation operation required for an artificial neural network operation.

The transistor MP12 for a switch performs a switch operation for interruption between the transistor MP11 for a current source and the membrane line MEM_{F}<0>.

The NAND gate ND11 controls the switch operation of the transistor MP12 for a switch. To this end, the NAND gate ND11 performs an AND operation on a synapse weight value W stored in the SRAM 213 and the pulse width modulation signal IN_{F}<0> having a duty ratio proportional to the multi-bit forward input value supplied from an exterior, and outputs a result value to the gate of the transistor MP12 for a switch.

While the transistor MP12 for a switch is maintained in an on state by the output signal of the NAND gate ND11, the transistor MP11 for a current source is connected to the column direction membrane line MEM_{F} which is an input line of the analog to digital converter 120, so that charge is supplied to the column direction membrane line MEM_{F}.

The backward operation unit 212 includes a transistor MP13 for a current source, which has one terminal (a source) connected to the power supply voltage VDD and a gate supplied with a backward bias voltage V_{B}_{_}_{B}, a transistor MP14 for a switch connected between the other terminal (a drain) of the transistor MP13 for a current source and the row direction membrane line MEM_{B}<0>, and a NAND gate ND12 which has one terminal connected to the output terminal of the SRAM 213, the other terminal supplied with a pulse width modulation signal IN_{B}<0> having a duty ratio proportional to a multi-bit backward input value, and an output terminal connected to a gate of the transistor MP14 for a switch.

The transistor MP13 for a current source serves as a current source that supplies the current for the multiplication accumulation operation required for the artificial neural network operation.

The transistor MP14 for a switch performs a switch operation for interruption between the transistor MP13 for a current source and the membrane line MEM_{B}<0>.

The NAND gate ND12 controls the switch operation of the transistor MP14 for a switch. To this end, the NAND gate ND12 performs an AND operation on the synapse weight value W stored in the SRAM 213 and the pulse width modulation signal IN_{B}<0> having a duty ratio proportional to the multi-bit backward input value supplied from an exterior, and outputs a result value to the gate of the transistor MP14 for a switch.

While the transistor MP14 for a switch is maintained in an on state by the output signal of the NAND gate ND12, the transistor MP13 for a current source is connected to the row direction membrane line MEM_{B} which is the input line of the analog to digital converter 120, so that charge is supplied to the row direction membrane line MEM_{B}.

In the embodiment of FIG. 2, an example in which the synapse circuit 210A includes all the forward operation unit 211 and the backward operation unit 212 so as to be able to perform the forward operation and the backward operation has been described; however, when it is not necessary to simultaneously perform the forward operation and the backward operation, two inputs are IN_{F}<0> and IN_{B}<0> and the output of an additional 2:1 multiplexer (MUX) having a control signal indicating forward or backward is connected to the other terminal of the NAND gate (ND11 or ND12), so that the forward operation unit 211 and the backward operation unit 212 may be shared.

In FIG. 2, the synapse circuit block 200A includes the six synapse circuits 210A having the same configuration, and the synapse circuit block 200B also includes the six synapse circuits 210B having the same configuration. Accordingly, at least six transistors for a current source are respectively provided in the synapse circuit blocks 200A and 200B for the forward or backward operation, and the column direction and row direction membrane lines MEM_{F}<y> and MEM_{B}<x> respectively connected to six lines respectively arranged in column (x) and row (y) directions are provided.

However, when the size of the current source is increased in order to reduce mismatch, the current source may occupy a considerable area in the synapse circuit 210A. In order to prevent this problem, it is possible to share the forward operation unit 211 and the backward operation unit 212 each including the transistor for a current source for the forward or backward operation, the transistor for a switch, and the NAND gate for controlling the switching operation of the transistor for a switch.

For example, in a time-interleaved method, the upper 3 bits may be first processed at a time in a 6-bit synapse and then the lower 3 bits may be processed at a time. In such a case, in the 6-bit synapse circuit blocks 200A and 200B, two synapse circuits 210A share one the forward operation unit 211 and one backward operation unit 212, respectively.

As described above, when one the forward operation unit 211 and one backward operation unit 212 are shared, the column direction and row direction membrane lines MEM_{F}<y> and MEM_{B}<x> and the analog to digital converters 120 respectively connected to these operation units are also shared.

Accordingly, for the multi-bit synapse operation, the forward operation unit 211 and the backward operation unit 212 may be configured from at least one through sharing to the number of bits of a maximum synapse without sharing.

The SRAM 213 stores the synapse weight value W.

To this end, the SRAM 213 includes inverters 11 and 12 in which input terminals are connected to output terminals of the other party.

The write operation unit 214 writes the synapse weight value W in the SRAM 213.

To this end, the write operation unit 214 includes a transistor MN11, which has one terminal (a drain) connected to the input terminal of the SRAM 213 and a gate supplied with the write enable signal WE, a transistor MN12, which has one terminal connected to the other terminal (a source) of the transistor MN11, the other terminal connected to a ground terminal, and a gate supplied with the synapse weight value W, a transistor MP15, which has one terminal (a source) connected to the power supply voltage VDD and a gate supplied with the synapse weight value W, and a transistor MP16 which has one terminal connected to the other terminal of the transistor MP15, the other terminal connected to the input terminal of the SRAM 213, and a gate supplied with the write enable bar signal WEB.

When the 6-bit synapse weight value W_{new} to be updated set in the neuronal processor 140 is transferred to the synapse circuit block 200A, the synapse weight value W_{new} is transferred to the write operation unit 214 of the synapse circuit 210A, so that a write operation for the SRAM 213 is performed. In such a case, the write operation for the SRAM 213 is controlled by the write enable signal WE<x> shared in the row direction of the multi-bit synapse array 110.

For example, when the write enable signal WE<x> of “high” is supplied to the gate of the transistor MN11, the transistor MN11 is turned on by this signal. In such a state, when the synapse weight value W_{new} of “high” to be updated is supplied to the gate of the transistor MN12, since one of two nodes of the SRAM 213, at which the synapse weight value W_{new} is inverted, is connected to the ground terminal through the transistors MN11 and MN12, “1” is written in the SRAM 213. In another example, when the write enable bar signal WEB<x> of “low” is supplied to the gate of the transistor MP16, the transistor MP16 is turned on by this signal. In such a state, when the synapse weight value W_{new} of “low” to be updated is supplied to the gate of the transistor MP15, since the power supply voltage VDD is supplied to one of the two nodes of the SRAM 213, at which the synapse weight value W_{new} is inverted, through the transistors MP15 and MP16, “0” is written in the SRAM 213.

The read operation unit 215 reads a weight value W already stored in the SRAM 213 before the synapse weight value W, to be updated is supplied to the SRAM 213 by the write operation unit 214, and transfers the weight value W to the neuronal processor 140. For reference, in order to represent the synapse weight value stored in the SRAM of the multi-bit synapse array 110, the alphabet W is used. The W value is updated when a synapse weight to be updated obtained through learning of the neuromorphic system 100 is written through the write operation unit 214. In such a case, in order to represent a synapse weight value to be updated for substituting a previous weight value stored in the multi-bit synapse array 110, the alphabet W_{new} is used.

To this end, the read operation unit 215 includes a transistor MN13, which has one terminal (a drain) connected to the read line W_{read} and a gate supplied with the read enable signal RE, a transistor MN14, which has one terminal connected to the other terminal (a source) of the transistor MN13, the other terminal connected to the ground terminal, and a gate connected to the input terminal of the SRAM 213, a transistor MP17, which has one terminal (a source) connected to the read line W_{read} and a gate supplied with the read enable bar signal REB, and a transistor MP18 which has one terminal connected to the other terminal of the transistor MP17, the other terminal connected to the power supply voltage VDD, and a gate connected to the input terminal of the SRAM 213.

When the read enable signal RE shared in the row direction of the multi-bit synapse array 110 is activated (“high”) and is transferred from the neuronal processor 140 to the read operation unit 215 of the synapse circuit 210A, weight values W stored in all SRAMs of one row are outputted to the read line W_{read} shared in the column direction of the multi-bit synapse array 110 through the read operation unit 215 and are transferred to the neuronal processor 140. In such a case, a read enable signal RE of all the other rows, except for one row of the multi-bit synapse array 110, is deactivated (“low”).

For example, when the read enable signal RE of “high” is supplied to the gate of the transistor MN13, the transistor MN13 is turned on by this signal. In such a state, when the synapse weight value W stored in the SRAM 213 is “0”, since “high” is supplied to the gate of the transistor MN14, the transistor MN14 is turned on, so that “0” is outputted to the read line W_{read}. In another example, when the read enable bar signal REB of “low” is supplied to the gate of the transistor MP17, the transistor MP17 is turned on by this signal. In such a state, when the synapse weight value W stored in the SRAM 213 is “1”, since “low” is supplied to the gate of the transistor MP18, the transistor MP18 is turned on, so that “1” is outputted to the read line W_{read} Meanwhile, when the read enable signal RE of “low” and the read enable bar signal REB of “high” are supplied to all the other rows, except for one row to be read of the multi-bit synapse array 110, so that the two the transistors MP17 and MN13 are all turned off. Accordingly, the shared read line W_{read} is not affected.

As described above, in the synapse circuit 210A, the transistor MP11 for a current source is connected to the column direction membrane line MEM_{F}<y> through the transistor MP12 for a switch such that the forward operation and the backward operation can be performed based on the synapse weight value W stored in the SRAM 213, and the transistor MP13 for a current source is connected to the row direction membrane line MEM_{B}<x> through the transistor MP14 for a switch. Accordingly, a charge amount proportional to a synapse weight and a multiplication accumulation operation value of input values is supplied to the membrane lines MEM_{F}<y> and MEM_{B}<x>, so that a transpose operation necessary for the forward and backward operations becomes possible.

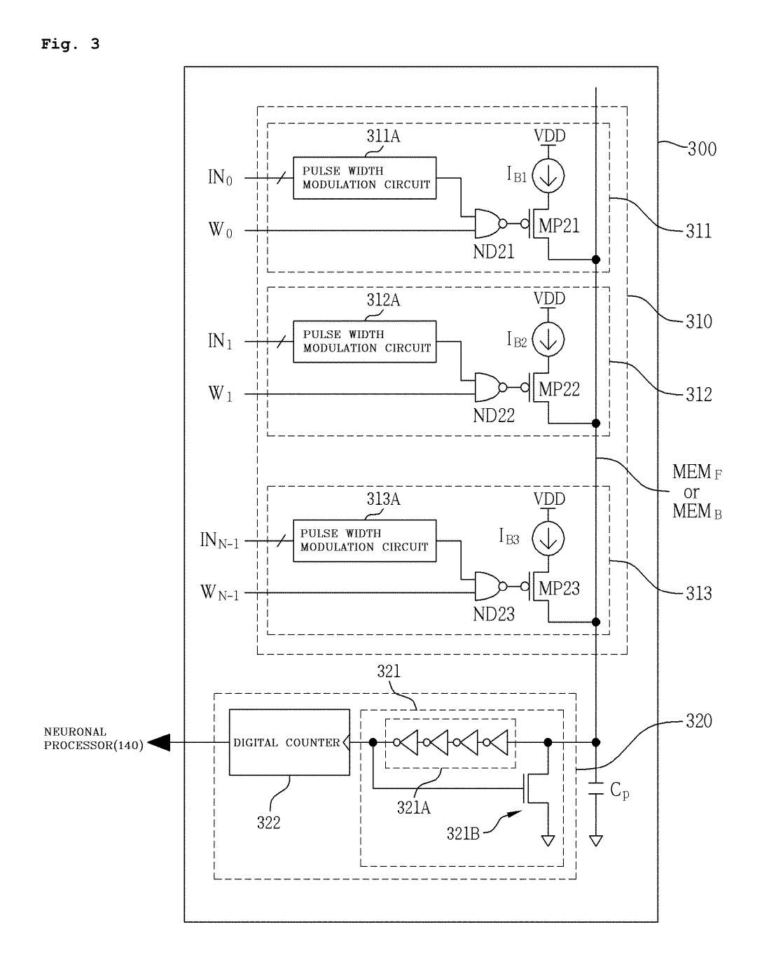

FIG. 3 illustrates a current-mode multiplier-accumulator provided in the neuromorphic system 100.

Referring to FIG. 3, a current-mode multiplier-accumulator 300 includes a charge output unit 310 and an analog to digital converter 320.

The charge output unit 310 includes charge output circuits 311 to 313 having the same configuration, which are commonly connected to the column direction or row direction membrane line, for example, the column direction membrane line MEM_{F} and output charge amounts according to corresponding synapse input values and synapse weight values.

Among the charge output circuits 311 to 313, one charge output circuit, for example, the charge output circuit 311 includes a current source IB₁ having one terminal connected to the power supply voltage VDD, a transistor MP21 for a switch connected between the other terminal of the current source IB₁ and the column direction or row direction membrane line, for example, the column direction membrane line MEM_{F}, a pulse width modulation circuit 311A that generates a pulse width modulation signal PWM having a duty ratio according to a multi-bit synapse input value IN₀, and a NAND gate ND21 that performs an AND operation on the pulse width modulation signal PWM outputted from the pulse width modulation circuit 311A and a synapse weight value W₀ and controls a switch operation of the transistor MP21 for a switch according to a result of the operation.

The analog to digital converter 320 includes a pulse generator 321 that generates pulses according to a charge voltage accumulated and charged in a parasitic capacitor C_{P} existing on the membrane line MEM_{F} in the column direction from the charge output unit 310, and a digital counter 322 that counts the number of pulses outputted from the pulse generator 321 and outputs a digital value according to the counted number.

The pulse generator 321 includes a comparator 321A that compares the voltage charged in the parasitic capacitor C_{P} with a reference voltage and generates a pulse according to the comparison result, and a transistor 321B for reset that resets the voltage charged in the parasitic capacitor C_{P} whenever “high” is outputted from the comparator 321A.

The artificial neural network implemented in the neuromorphic system 100 performs a multiplication accumulation operation as expressed by the following Equation 3 in order to perform the forward or backward operation.

$$OUT = {\sum }_{i = 0}^{N - 1} {IN}_{i} \times {W}_{i} \qquad Equation 3$$

In Equation 3 above, INᵢ denotes a multi-bit synapse input value inputted to an i^{th} synapse for the forward or backward operation and Wᵢ denotes the synapse weight value of the i^{th} synapse. N denotes the size of the row or column of the multi-bit synapse array 110.

The multiplication accumulation operation of Equation 3 above is performed in an analog domain, other than a digital domain, by the charge output circuits 311 to 313.

As an example of the i^{th} multi-bit synapse input value INᵢ, the first multi-bit synapse input value IN₀ is modulated into a pulse width modulation signal having a duty ratio proportional to the input value in the pulse width modulation circuit 311A. The synapse input value modulated into time information is ANDed with the synapse weight value W₀ in the NAND gate ND21. An output signal of the NAND gate ND21 is supplied to a gate of the transistor MP21 serially connected to the current source IB₁ of the synapse circuit. Accordingly, while an output value of the NAND gate ND21 is “0”, since the transistor MP21 for a switch is turned on, charge Qᵢ as expressed by the following Equation 4 is supplied to the parasitic capacitor C_{P} existing on the membrane line MEM_{F} through the current source IB₁ and the transistor MP21 for a switch.

Qᵢ=I_{B}×INᵢ×Wᵢ Equation 4

When the number of rows or columns of the multi-bit synapse array 110 is N, charge outputted from the charge output circuits 311 to 313 connected to the rows or columns of the multi-bit synapse array 110 is accumulated and charged in the parasitic capacitor C_{P}. Accordingly, the accumulated charge voltage V of the parasitic capacitor C_{P} is expressed by the following Equation 5.

$$V = \frac{{\sum }_{i = 0}^{N - 1} {Q}_{i}}{{C}_{P}} = \frac{{I}_{B} \times {\sum }_{i = 0}^{N - 1} ( {IN}_{i} \times {W}_{i} )}{{C}_{P}} \qquad Equation 5$$

Accordingly, the charge voltage V of the parasitic capacitor C_{P} is an analog signal having a value according to the multiplication operations of the NAND gates ND21 to ND23 and the charge accumulation operation.

The analog to digital converter 320 converts the analog charge voltage charged in the parasitic capacitor C_{P} into a digital signal and outputs the digital signal.

The pulse generator 321 of the analog to digital converter 320 compares the charge voltage of the parasitic capacitor C_{P} with the reference voltage and generates a pulse according to the comparison result. The comparator 321A of the pulse generator 321 can be implemented by a buffer stage including a plurality of (even number of) inverters connected in series without using an external reference voltage. In such a case, a logic threshold voltage of the first inverter is used as the reference voltage. Accordingly, in an initial state, since the level of the charge voltage of the parasitic capacitor C_{P} is a level of the ground voltage GND, the output of the buffer stage is “low”, so that the transistor 321B for reset is maintained in an off state. Then, when the charge voltage of the parasitic capacitor C_{P} is higher than the reference voltage by the multiplication operations of the NAND gates ND21 to ND23 and the charge accumulation operation, since the output of the buffer stage is “high”, the transistor 321B for reset is turned on, so that the charge voltage of the parasitic capacitor C_{P} is reset. Through such a process, one pulse is generated from the comparator 321A. The comparison operation of the comparator 321A and the charge voltage reset operation of the parasitic capacitor C_{P} by the transistor 321B for reset are repeatedly performed until the charge voltage of the parasitic capacitor C_{P} by the multiplication accumulation operation is consumed. Accordingly, the total number of pulses generated through the pulse generator 321 is proportional to a result of the multiplication accumulation operation.

The digital counter 322 counts the number of pulses outputted from the pulse generator 321 and outputs a digital value according to the counted number to the neuronal processor 140.

In the above example, the synapse input value IN of the current-mode multiplier-accumulator 300 is multi-bits and the synapse weight value W is 1b.

In order to expand such a structure to the multi-bit synapse weight of the multi-bit synapse array 110, it is necessary to compensate and add weights according to the number of bits of the synapse weight by bits. To this end, it is possible to compensate for the current value of the current source I_{B} of the synapse which is an analog domain or the output value of the digital counter 322 which is a digital domain.

Since the current-mode multiplier-accumulator 300 as above is implemented by an analog circuit instead of a digital multiplier and a digital adder, the current-mode multiplier-accumulator 300 can be implemented with low power and small area. The calculation result of the current-mode multiplier-accumulator 300 is not accurate as compared with a digital circuit, but can be compensated to some extent by on-chip learning.

FIG. 4 is a detailed block diagram of the neuronal processor 140. As illustrated in FIG. 4, the neuronal processor 140 includes a decoder 141, a virtual look-up table 142, a demultiplexer 143, an accumulator 144, and a tri-level function unit 145. The decoder 141 outputs a corresponding address value by using all or partial bits of a column component used in order to calculate a synapse update change amount as input. The virtual look-up table 142 stores a calculation value related to the synapse update change amount by using all bits or only partial bits of the column component on the basis of a row component required for calculating the synapse update change amount and the corresponding address value and stores a calculation value generated again whenever the row component is changed. The demultiplexer 143 distributes the output of the virtual look-up table 142 to two paths according to a batch signal Batch indicating whether batch learning is performed and outputs the output. The accumulator 144 accumulates the output of the virtual look-up table 142. The tri-level function unit 145 receives the output of the demultiplexer 143 and the output of the accumulator 144 and outputs the synapse update change amount as +1, 0, and −1.

The decoder 141 receives the column component as input and outputs the address values of the virtual look-up table 142.

The virtual look-up table 142 receives the address values from the decoder 141 and outputs a result value calculated in advance. Since the neuromorphic system 100 updates one row of the multi-bit synapse array 110 at a time according to the write enable signal WE<i>, the row order i is fixed and the column order j is changed from 0 to N-1 in order to obtain a synapse update change amount ΔW of one row. As described above, since the row order is fixed, the row component used in order to obtain the synapse update change amount may be repeatedly used while the synapse update change amount of one row is obtained. Accordingly, the virtual look-up table 142 can be generated from the row component. The virtual look-up table 142 may store in advance a calculation value related to the synapse update change amount by using all bits or only partial bits of the column component used in order to obtain the synapse update change amount ΔW. The virtual look-up table 142 as above is generated whenever the row component is changed.

Meanwhile, the batch is an algorithm technique used in order to accelerate a learning speed, and updates a synapse update change amount, which is obtained by multiple inputs, at a time rather than multiple times through averaging. To this end, the demultiplexer 143 transfers input to the accumulator 144 or directly transfers the input to the tri-level function unit 145 according to the batch signal Batch which is a control signal.

The accumulator 144 accumulates the output value of the virtual look-up table 142.

The tri-level function unit 145 receives the output of the demultiplexer 143 and the output of the accumulator 144 and outputs the synapse update change amount. That is, the tri-level function unit 145 converts the output into three levels (+1, 0, and −1) by using the following Equation 6 and outputs a synapse update change amount ΔWᵢⱼ.

$$y ( x ) = \{ \begin{matrix}+ 1 , & x > 0 \\ 0 , & x = 0 \\ - 1 , & x < 0\end{matrix} ↵ \qquad Equation 6$$

In the example described above, the synapse update change amount ΔWᵢⱼ is simplified to three levels through the tri-level function unit 145 and is outputted; however, the present disclosure is not limited thereto and the synapse update change amount ΔWᵢⱼ may be appropriately changed to different functions according to a data set of the neuromorphic system 100.

The neuromorphic system 100 prepares in advance repeated calculation results by using the aforementioned virtual look-up table 142, so that a large amount of operations required for neuromorphic learning are reduced. Accordingly, it is possible to reduce hardware cost required for performing a synapse weight update in a row-by-row manner in the neuromorphic system 100.

The neuromorphic system 100 is designed with a CMOS 28 nm process and performs an operation for restoring input data again through unsupervised learning by using a modified national institute of standards and technology database (MNIST), which is a handwritten data set, as input, and (a) to (c) of FIG. 5 illustrate images related thereto.

That is, (a) of FIG. 5 illustrates 70 MNIST images used as inputs. (b) of FIG. 5 illustrates MNIST images restored by the neuromorphic system 100 having a random synapse weight when no unsupervised learning has been performed. (c) of FIG. 5 illustrates MNIST images restored by the neuromorphic system 100 after the synapse weight is updated through the unsupervised learning.

In the above description, the reference marks “MP” and “MN” of the transistors respectively indicate a P channel MOS transistor and a N channel transistor.

Furthermore, FIG. 2 and FIG. 3 have described an example in which in order to cope with the use of the PMOS transistors MP12, MP14, and MP21 to MP23 as switch transistors, the NAND gates ND11, ND12, and ND21 to ND23 are used as logical elements for controlling the driving of the PMOS transistors. Accordingly, when another type of element (for example, a NMOS transistor) is used as the switch transistor, another logical element (for example, an AND gate) may be used as a logical element for controlling the driving of the element.

While various embodiments have been described above, it will be understood to those skilled in the art that the embodiments described are by way of example only. Accordingly, the disclosure described herein should not be limited based on the described embodiments.

What is claimed is:

1. A neuromorphic system with a transposable memory and a virtual look-up table, comprising:
a multi-bit synapse array including a plurality of synapse circuits based on a SRAM structure;
an analog to digital converter that converts a voltage charged in a membrane line by charge supplied according to a multiplication accumulation operation result in the multi-bit synapse array into a digital value;
a pulse width modulation circuit that generates a pulse width modulation signal having a duty ratio proportional to a multi-bit digital input value and outputs the pulse width modulation signal to the multi-bit synapse array; and
a neuronal processor that receives output data of the analog to digital converter, outputs the multi-bit digital input value, transfers forward and backward input values supplied from an exterior to the multi-bit synapse array, applies a nonlinear function to the multiplication accumulation operation result so as to perform processing required after a multiplication accumulation operation of an artificial neural network, and updates a synapse weight value of the multi-bit synapse array in a direction in which an error is reduced using a learning algorithm.

2. The neuromorphic system with the transposable memory and the virtual look-up table according to claim 1, wherein at least one of the plurality of synapse circuits comprises:
transistors for a current source each having one terminal connected to a power supply voltage and a gate supplied with a bias voltage for a forward operation or a bias voltage for a backward operation;
a transistor for a switch connected between the other terminal of the transistor for a current source and a membrane line; and
a NAND gate that controls a switching operation of the transistor for a switch.

3. The neuromorphic system with the transposable memory and the virtual look-up table according to claim 2, wherein the NAND gate has one terminal connected to an output terminal of a SRAM, the other terminal supplied with a pulse width modulation signal having a duty ratio proportional to a forward or backward input value, and an output terminal connected to a gate of the transistor for a switch.

4. The neuromorphic system with the transposable memory and the virtual look-up table according to claim 2, wherein the transistor for a switch transfers charge supplied from the transistor for a current source to the membrane line in an on state.

5. The neuromorphic system with the transposable memory and the virtual look-up table according to claim 2, wherein the transistors for a current source separately exist or are shared as one for the forward operation and the backward operation of the neuromorphic system.

6. The neuromorphic system with the transposable memory and the virtual look-up table according to claim 1, wherein the membrane line is connected to the synapse circuit arranged in a row and a column on the multi-bit synapse array.

7. The neuromorphic system with the transposable memory and the virtual look-up table according to claim 1, wherein the membrane line is arranged by one or by the number of bits of a synapse through synapse sharing.

8. The neuromorphic system with the transposable memory and the virtual look-up table according to claim 1, wherein the analog to digital converter comprises:
a pulse generator that generates pulses according to a charge voltage accumulated and charged in a parasitic capacitor existing on the membrane line; and
a digital counter that counts the number of pulses outputted from the pulse generator and outputs a digital value according to the counted number.

9. The neuromorphic system with the transposable memory and the virtual look-up table according to claim 8, wherein the pulse generator comprises:
a comparator that compares the voltage charged in the parasitic capacitor with a reference voltage and generates a pulse according to the comparison result; and
a transistor for reset that resets the voltage charged in the parasitic capacitor whenever “high” is outputted from the comparator.

10. The neuromorphic system with the transposable memory and the virtual look-up table according to claim 9, wherein the comparator includes a plurality of inverters connected in series.

11. The neuromorphic system with the transposable memory and the virtual look-up table according to claim 1, wherein the neuronal processor comprises:
a decoder that outputs a corresponding address value by using all or partial bits of a column component used in order to calculate a synapse update change amount as input;
a virtual look-up table that stores a calculation value related to the synapse update change amount by using all bits or only partial bits of the column component on the basis of a row component required for calculating the synapse update change amount and the corresponding address value and stores a calculation value generated again whenever the row component is changed;
a demultiplexer that distributes output of the virtual look-up table to two paths according to a batch signal indicating whether batch learning is performed and outputs the output;
an accumulator that accumulates the output of the virtual look-up table; and
a tri-level function unit that receives output of the demultiplexer and output of the accumulator and outputs the synapse update change amount as three levels of information.

12. The neuromorphic system with the transposable memory and the virtual look-up table according to claim 11, wherein the demultiplexer transfers the output of the virtual look-up table to the tri-level function unit when a control signal of “low” is supplied and transfers the output of the virtual look-up table to the accumulator when a control signal of “high” is supplied.

13. The neuromorphic system with the transposable memory and the virtual look-up table according to claim 11, wherein the tri-level function unit receives an accumulated synapse update change amount or the synapse update change amount as input, outputs 1 when the input is larger than 0, outputs −1 when the input is smaller than 0, and outputs 0 when the input is 0.

14. The neuromorphic system with the transposable memory and the virtual look-up table according to claim 1, wherein the neuromorphic system adds the synapse update change amount to a synapse weight stored in the multi-bit synapse array and updates the synapse weight in a row-by-row manner.
